(19) United States
(12) Patent Application Publication
(10) Pub. No.: US 2011/0138933 A1
(43) Pub. Date: Jun. 16, 2011

(54) SENSOR HAVING EMI SHIELDING FOR MEASURING ROTATING SHAFT PARAMETERS

(75) Inventors: Anilkumar RAMSESH, Bangalore (IN); Vijay TALIKOTI, Bangalore (IN); Ion GEORGESCU, Bucharest (RO)

(73) Assignee: HONEYWELL INTERNATIONAL INC., Morristown, NJ (US)

(21) Appl. No.: 12/638,165

(22) Filed: Dec. 15, 2009

(51) Int. Cl. G01L 3/10

(52) U.S. Cl. 73/862.333

(57) ABSTRACT

An EMI shielded sensing system is for measuring parameters associated with a rotating device having a rotating shaft. The system includes a rotating unit mechanically coupled to the rotating shaft. The rotating unit includes a sensor that provides a sensing signal that is coupled to a first antenna. A stationary unit includes a second antenna. The stationary unit and rotating unit are in wireless communication via a wireless link, and the stationary unit provides RF energy to power the rotating unit over the wireless link. The rotating unit sends the sensing output to the stationary unit over the wireless link. A multi-metal shroud for EMI shielding is positioned around the rotating unit and stationary unit. The shroud includes a ferromagnetic layer and a non-ferromagnetic layer.

### FIELD

Disclosed embodiments related to sensing systems including a wireless link for sensing rotating shaft parameters, such as torque.

### BACKGROUND

Rotating systems are commonly used in manufacturing and power generation. By sensing torque on these systems, process control can be instituted so that downtime can be reduced, product quality improved and energy efficiency maximized. For example, a lumber mill can use a predetermined maximum torque as a criterion to initiate blade changes. This saves wear and tear on the drive system and increases product quality. Many similar applications exist in manufacturing. Monitoring torque is sometimes critical to the performance of axles, drive trains, gear drives, and electric and hydraulic motors. Other in-plant applications include gas and steam turbines.

Most torque measuring systems require rotational movement of the measuring system to generate torque information. In one arrangement referred to as non-contact sensing system, the sensing system comprises a rotating unit including at least one strain gauge and a stationary unit that provides power to the rotating unit, wherein the rotating unit and the stationary unit are separated by a gap. Radio telemetry provides a solution for bridging the stationary-rotating gap.

A stationary antenna on the stationary unit transmits power over the gap to the rotating shaft antenna on the rotating shaft. The power received by the rotating shaft antenna is conditioned and excites the strain gauge(s). A shaft-mounted radio transmitter sends the measurement signal back to the stationary antenna for signal processing.

### SUMMARY

Disclosed embodiments described herein include electromagnetic interference (or EMI, also called radio frequency interference or RFI) shielded sensing systems that measure at least one parameter (e.g., torque) of a rotating shaft. The sensing system comprises a rotating unit mechanically coupled to the rotating shaft. The rotating unit comprises at least one sensor for sensing the parameter, wherein the sensor provides a sensing signal that is used to generate a sensing output that is coupled to a first antenna. A stationary unit spaced apart from the rotating unit includes a second antenna.

The stationary unit and rotating unit are in wireless communication via a wireless link. The stationary unit provides RF energy to power the rotating unit over the wireless link, while the rotating unit provides the sensing output over the wireless link to the stationary unit. The Inventors have recognized that the EM or RF energy that is coupled between the stationary unit and the rotating unit generates EMI that may result in electromagnetic compatibility (EMC) problems for certain circuitry outside the sensing system, such as the interruption, obstruction, degradation or limiting of the effective performance of the surrounding circuitry.

To limit EMI/EMC emissions from the sensing system, such as to enable meeting certain emission requirements (e.g., FCC), disclosed embodiments include a multi-metal shroud that is placed around the rotating unit and stationary unit. The multi-metal shroud includes a ferromagnetic metal portion including at least one ferromagnetic metal and electrically conducting portion comprising at least one non-ferromagnetic metal.

As described in detail below, the ferromagnetic metal portion acts as a Faraday shield containing the magnetic field within the shroud. The electrically conducting metal portion acts as an Eddy current guard that reduces the magnetic field radiation within the multi-metal shroud by opposing the primary magnetic flux of the time-varying magnetic field.

### BRIEF DESCRIPTION OF THE DRAWINGS

FIG. 1 is a depiction of an EMI shielded sensing system for measuring at least one parameter associated with a rotating device, wherein the multi-metal shroud that provides the EMI shielding is cut upon to show only its back wall to reveal the other system components, according to a disclosed embodiment.

FIG. 2 is depiction of the Faraday cage effect on the magnetic flux path provided by an exemplary multi-metal shroud disclosed herein.

FIG. 3 is a depiction of the Eddy current effect and the counter magnetic field generated due to the Eddy currents by multi-metal shrouds disclosed herein.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate the disclosed embodiments. Several aspects disclosed herein are described below with reference to example applications for illustration. It should be understood that numerous specific details, relationships, and methods are set forth to provide a full understanding of the disclosed embodiments and their equivalents. One having ordinary skill in the relevant art, however, will readily recognize that the disclosed embodiments can be practiced without one or more of the specific details or with other methods. In other instances, well-known structures or operations are not shown in detail to avoid obscuring aspects of the disclosed embodiments. Disclosed embodiments are not limited by the illustrated ordering of acts or events, as some acts may occur in different orders and/or concurrently with other acts or events. Furthermore, not all illustrated acts or events are required to implement a methodology in accordance with the disclosed embodiments of their equivalents.

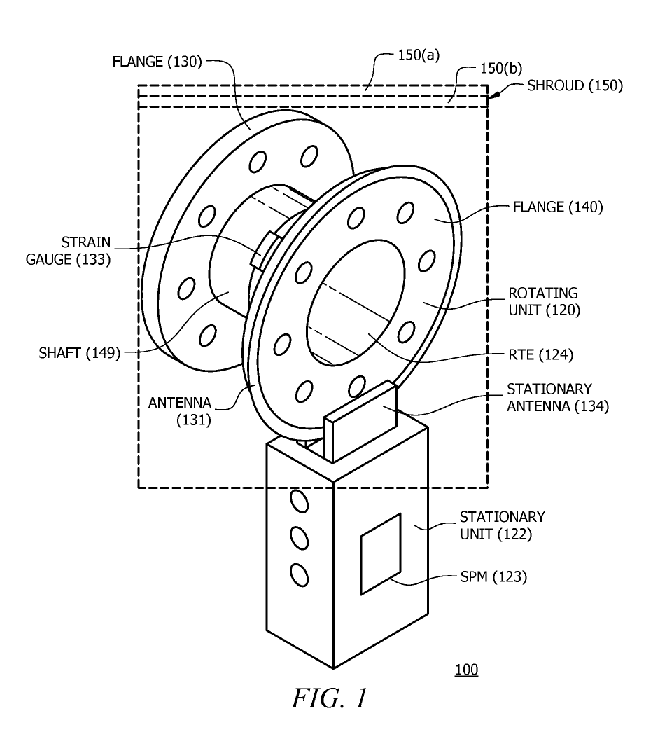

FIG. 1 is a depiction of an EMI shielded sensing system 100 for measuring at least one parameter associated with a rotating device, wherein a multi-metal comprising shroud 150 which provides EMI shielding is cut open to show only the back wall of the shroud to reveal the other components of system 100, according to a disclosed embodiment. The sensing system 100 comprises a rotating unit 120, a rotor electronics module (i.e., RTE) 124 located (centrally or peripherally) on the rotating unit 120, a rotating antenna 131 which is part of the rotating unit 120, and a stationary unit 122 having a stationary antenna 134 positioned proximate to the rotating antenna 131.

Rotating unit 120 and stationary unit 122 communicate bi-directionally over a wireless link. As described below, the multi-metal shroud 150 is configured to (i) generate Eddy currents to reduce the net magnetic field by generating magnetic flux oriented to oppose the magnetic flux emitted by the stationary unit 140 and rotating unit 120 during wireless communications over their wireless link and (ii) by acting as a Faraday shield to help contain the reduced net magnetic field within the multi-metal shroud 150 during wireless communications occurring within the multi-metal shroud 150.

Stationary unit 122 is shown including a signal processing module 123 (i.e. SPM). However, in another embodiment (not shown), SPM 123 is positioned remote from stationary unit 122. SPM 123 can integrate two microprocessors to share data processing and communications. SPM 123 can recover the sensing signal from the rotating unit 120, provide scaling and filtering, and offer a variety of outputs, as well as compatibility with a variety of data acquisition systems.

Rotating unit 120 is shown having two flanges 130 and 140 with a central shaft or tube-like rigid connection piece shown in FIG. as shaft 149 between them. This central piece 149 may have one or more strain gauges 133 (e.g., four (4) in a Wheatstone bridge circuit configuration) bonded to it for purposes of sensing a torque between flanges 130 and 140. For one application of system 100, a power drive shaft may be coupled to one flange and a load driving shaft may be coupled to the other flange.

Stationary antenna 134 of a stationary unit 122 may receive the telemetry-type signals from rotating antenna 131. Also such type of signals may be emanated from stationary antenna 134 to rotating antenna 131. Moreover, power signals may be emanated from stationary antenna 134 to rotating antenna 131, in that stationary antenna 134 and rotating antenna 131 may be like primary and secondary windings, respectively, of an air gap transformer for transferring power to rotating unit 120 for powering the RTE 124. The distance between rotating antenna 131 and stationary antenna 134 may be an air gap of a significant distance, such as up to 5-6 mm. However, the air gap may be more or less than 5-6 mm. Rotating antenna 131 may be as much as 6 inches (15.4 cm) from the main body of the stationary unit 122 during the transmission of signals and power between them. Although multi-metal shroud 150 is shown with only its back wall to reveal components of system 100, multi-metal shroud 150 is positioned around to substantially enclose the rotating unit 120 and the stationary unit 122.

The multi-metal shroud 150 includes a ferromagnetic metal portion shown as a ferromagnetic layer 150(b) that comprises at least one ferromagnetic metal (e.g., Co, Ni or Fe) positioned as the inner portion of multi-metal shroud 150. The ferromagnetic layer 150(b) and electrically conducting layer 150(a) have different compositions. Multi-metal shroud 150 also includes an electrically conducting portion shown as an electrically conducting layer 150(a) that comprising at least one non-ferromagnetic metal shown as the outer portion of multi-metal shroud 150. However, the positions of electrically conducting layer 150(a) and ferromagnetic layer 150(b) may be reversed so that the ferromagnetic layer is the outer portion of the multi-metal shroud and the electrically conducting layer provides the inside portion of multi-metal shroud.

As shown in FIG. 1, the ferromagnetic metal layer 150(b) and electrically conducting layer 150(a) are electrically in parallel. In another embodiment, the ferromagnetic metal portion and electrically conducting portion are provided by a single composite material that provides both at least one ferromagnetic metal and at least one non-ferromagnetic metal, such as Mu-metal described below.

In the multi-metal shroud 150 embodiment shown in FIG. 1, the electrically conducting layer 150(a) is generally substantially thinner as compared to the thickness of ferromagnetic layer 150(b). For example, in one particular embodiment, the thickness of electrically conducting layer 150(a) is 5 to 20 μm, such as 12.7 μm, and the thickness of the ferromagnetic layer 150(b) is 1 to 4 mm, such as 1.89 mm. In this particular embodiment, the total thickness of multi-metal shroud 150 is set primarily by the thickness of the ferromagnetic layer 150(b), such as around 2 mm.

As used herein, the term “ferromagnetic metal” as in “ferromagnetic metal portion” refers to a material that provides a magnetic permeability (μ) of at least 500 μN/A² at 0.002 T and zero frequency. As described above, the ferromagnetic material can be an iron or a ferrous alloy, such as steel. In one embodiment, ferromagnetic material comprises a ferromagnetic metal composite, such as Mu-metal. Mu-metal is a nickel-iron alloy (75% nickel, 15% iron, plus copper and molybdenum) that has a very high magnetic permeability of about 25,000 μN/A² at 0.002 T and zero frequency. Mu-metal and similar composite materials can be used in the single composite material embodiment for multi-metal shroud 150.

A high magnetic permeability layer is generally effective at screening magnetic fields. Thus, ferromagnetic metal layer 150(b) has been found to act as a Faraday shield to contain the magnetic field radiation emitted by the stationary unit 140 and rotating unit 120 during wireless communications over their wireless link within the multi-metal shroud 150. Moreover, multi-metal shroud 150 may also block RF noise from coupling into the wireless link.

In the multi-metal shroud 150 embodiment shown in FIG. 1 that comprises separate electrically conducting layer 150(a) and ferromagnetic layer 150(b), the bulk electrical conductivity (such as at around 25° C.) of the electrically conducting layer 150(a) can be significantly greater than the bulk electrical conductivity of the ferromagnetic layer 150(b). For example, the electrically conducting layer 150(a) can provide an electrical conductivity that is >10 times greater than the electrical conductivity of the ferromagnetic layer 150(b).

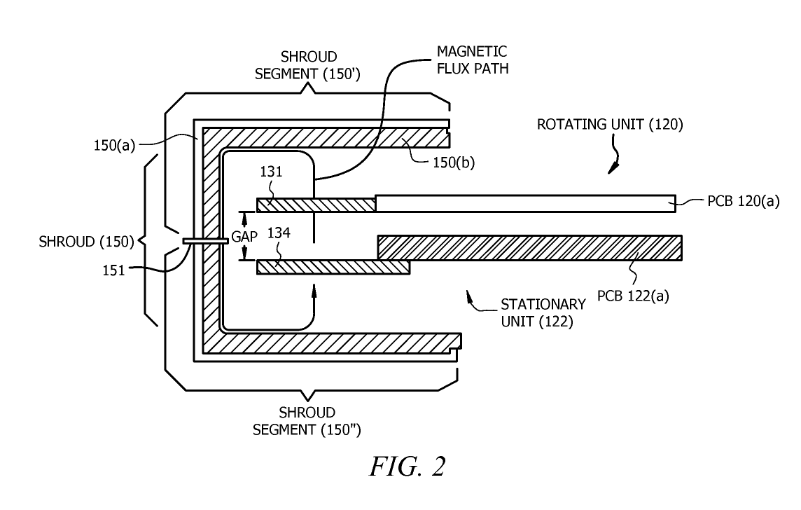

The multi-metal shroud 150 can be built in multiple parts or segments, such as in 2 segments (see FIG. 2 described below). When embodied in multiple parts or segments, the parts or segments of multi-metal shroud 150 are electrically coupled so that the multi-metal shroud 150 acts a single short circuited ring or guard.

Since system 100 provides energy and data capture to and from rotating shafts, the telemetry mechanism may use an RF transformer operating at, for example, a fundamental RF carrier frequency of 6.78 MHz to transfer power across the stationary unit 122-rotating unit 120 gap. Modulation such as amplitude shift keying (ASK) digital signal modulation of the same RF carrier can be used to transmit a limited number of codes to the rotating unit 120 to receive measurement data from the rotating unit 120 to the stationary unit 122. The RF carrier with the codes may be demodulated at the rotating unit 120. Also, the measurement data may be modulated with ASK on an RF carrier when being transmitted from the rotating unit 120. Measurement data may be demodulated at the stationary unit 122. Other kinds of modulation and demodulation may be used.

The electrically conducting portion such as electrically conducting layer 150(a) provides an Eddy current guard. Due to the time varying magnetic field, an electromotive force (EMF) is generated by stationary unit 122 and rotating unit 120 so that a voltage will be induced in the electrically conducting portion of shroud (and to a lesser degree in the generally less electrically conductive ferromagnetic metal portion). This EMF will have an associated current that generates a magnetic field which will be in a direction opposing the primary magnetic flux of the time varying magnetic field. Thus, dynamically the total net electromagnetic radiation is reduced. Multi-metal shroud 150 thus reduces EMI emitted by system 100 by reducing the net magnetic flux and also containing the reduced net magnetic flux.

FIG. 2 is a depiction of the Faraday cage effect on the magnetic flux path provided by a multi-metal shroud disclosed herein. Rotating unit 120 is shown on a printed circuit board (PCB) 120(a), while stationary unit 122 is shown on a second PCB 122(a). The ferromagnetic metal portion 150(b) of the multi-metal shroud 150 can act as a Faraday shield containing the magnetic field radiation with a typical magnetic flux path depicted in FIG. 2.

The multi-metal shroud 150 is shown in FIG. 2 to comprise at least two segments 150′ and 150″ that are short circuited to one another. Short circuiting can be provided by a weld or solder material 151 as shown in FIG. 2.

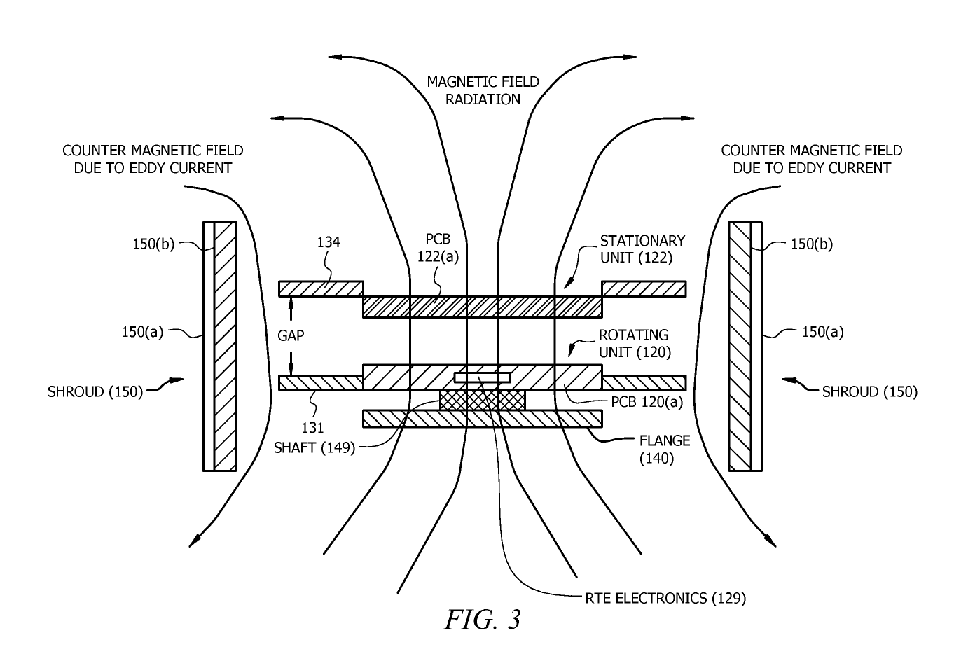

FIG. 3 is a depiction of the Eddy current effect and the counter magnetic field generated due to the Eddy currents by multi-metal shrouds disclosed herein. RTE electronics 129 is now shown on PCB 120(a) of rotating unit 120. The multi-metal shroud 150 has a voltage induced due to the received time varying magnetic field. This EMF/voltage will have an associated circulating flow of electrons, or a current, within the body of the multi-metal shroud principally in the electrical conducting portion shown as electrically conducting layer 150(a) in the layered shroud embodiment shown in FIG. 1 that generates a magnetic field which is oriented to oppose the primary magnetic flux of the time varying magnetic field due to Lenz's law. Thus, dynamically the total (i.e. net) electromagnetic radiation within multi-metal shroud 150 is reduced. The strength of the eddy current can be increased to increase the magnitude of the opposing magnetic flux by thickening the electrically conducting portion or using a low resistivity material (e.g., aluminum, tin, copper, silver).

Multi-metal shrouds disclosed herein are useful in digital wireless telemetry systems that supply power to rotating sensors, and support two-way wireless communications. Applications include measuring torque (and other parameters) within rotating shafts, as typically found in dynamometers for engine and transmission testing. Also, such systems including multi-metal shrouds disclosed herein can be used for a wide variety of other applications such as turbine testing, pump testing, NVH testing of gear trains and power measurement within propulsion systems. Existing sensing system can be retrofitted with multi-metal shrouds to provide EMI shielding, such as by using the multi-metal shroud comprising two segments shorted together as shown in FIG. 2 to facilitate installation in a sensing system already in service.

While various embodiments have been described above, it should be understood that they have been presented by way of example only, and not limitation. Numerous changes to the disclosed embodiments can be made in accordance with the disclosure herein without departing from the spirit or scope of the disclosed embodiments. Thus, the breadth and scope of the disclosed embodiments should not be limited by any of the above explicitly described embodiments. Rather, the scope of the invention should be defined in accordance with the following claims and their equivalents.

Although the disclosed embodiments have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting to embodiments of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which the disclosed embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

1. An EMI shielded sensing system for measuring at least one parameter associated with a rotating device having a rotating shaft, said system comprising:
a rotating unit mechanically coupled to said rotating shaft comprising a sensor for sensing said parameter and providing a sensing signal, wherein a sensing output based on said sensing signal is coupled to a first antenna;
a stationary unit including a second antenna, wherein said stationary unit and said rotating unit are in wireless communication via a wireless link, said stationary unit providing RF energy to power said rotating unit including said sensor over said wireless link and said rotating unit sending said sensing output to said stationary unit over said wireless link, and
a multi-metal shroud for EMI shielding around said rotating unit and said stationary unit, said multi-metal shroud comprising:
a ferromagnetic metal portion comprising a ferromagnetic layer including at least one ferromagnetic metal; and
an electrically conducting portion comprising a non-ferromagnetic layer including at least one non-ferromagnetic metal,
wherein said ferromagnetic layer and said non-ferromagnetic layer are electrically in parallel.

2. The system of claim 1, wherein a bulk electrical conductivity of said non-ferromagnetic layer is >10 times greater than a bulk electrical conductivity of said ferromagnetic layer.

3. The system of claim 1, wherein said sensor comprises a torque sensor and said parameter comprises torque.

4. The system of claim 1, wherein said multi-metal shroud comprises at least two segments that are short circuited to one another.

5. The system of claim 1, wherein said ferromagnetic layer comprises steel.

6. An EMI shielded sensing system for measuring at least one parameter associated with a rotating device having a rotating shaft, said system comprising:
a rotating unit mechanically coupled to said rotating shaft comprising a sensor for sensing said parameter and providing a sensing signal, wherein a sensing output based on said sensing signal is coupled to a first antenna;
a stationary unit including a second antenna, wherein said stationary unit and said rotating unit are in wireless communication via a wireless link, said stationary unit providing RF energy to power said rotating unit including said sensor over said wireless link and said rotating unit sending said sensing output to said stationary unit over said wireless link, and
a multi-metal shroud around said rotating unit and said stationary unit, said multi-metal shroud comprising:
a ferromagnetic metal portion including at least one ferromagnetic metal, and
an electrically conducting portion comprising at least one non-ferromagnetic metal.

7. The system of claim 6, wherein said ferromagnetic metal portion and said electrically conducting portion comprise a ferromagnetic layer and a non-ferromagnetic layer, respectively, and wherein said ferromagnetic layer and said non-ferromagnetic layer are electrically in parallel.

8. The system of claim 6, wherein said ferromagnetic metal portion and said electrically conducting portion are provided by a single composite material that provides both said ferromagnetic metal and said non-ferromagnetic metal.

9. The system of claim 6, wherein said sensor comprises a torque sensor and said parameter comprises torque.

10. The system of claim 6, wherein said ferromagnetic metal portion comprises steel.

11. The system of claim 6, wherein said rotating unit includes two flanges and a central connection piece between them, and said sensor is bonded to said central connection piece.

12. The system of claim 6, wherein said rotating unit comprises a rotor electronics module for receiving and conditioning said sensing signal to generate said sensing output.

13. The system of claim 6, wherein said system further comprises a signal processing module (SPM), wherein said sensing output is received by said SPM.

14. The system of claim 13, wherein said SPM is disposed on said stationary unit.

15. The system of claim 6, wherein said multi-metal shroud comprises at least two segments that are short circuited to one another.

17. The system of claim 6, wherein said a rotating unit comprises a first printed circuit board (PCB) and said stationary unit comprises a second PCB, and wherein said first antenna and said second antenna both comprise coil antennas.
